(19) United States
(12) Patent Application Publication
(10) Pub. No.: US 2011/0260625 A1
(43) Pub. Date: Oct. 27, 2011

(54) METHOD AND APPARATUS FOR POWERING ONE OR MORE LOADS FROM AN AC SOURCE USING A CAPACITIVE BALLAST

(75) Inventors: Naraish K. Gautam, Chagrin Falls, OH (US); Elmer L. Griebeler, Chesterland, OH (US)

(73) Assignees: TUROCY & WATSON, LLP., Cleveland, OH (US); CONDUCTANCE ENGINEERING, INC, Chagrin Falls, OH (US)

(21) Appl. No.: 12/764,565

(22) Filed: Apr. 21, 2010

(51) Int. Cl. H05B 37/02

(52) U.S. Cl. 315/127; 315/250; 315/294

(57) ABSTRACT

Described are circuits and methods for powering one or more loads from an ac source using a capacitive ballast. The circuit comprises a capacitive voltage divider that limits current to the loads, includes a first capacitor that operates as a ballast creating a leading current draw relative to the voltage from an alternating current source, and includes a second capacitor that protects the set of light emitting diodes by suppressing line transients. The circuit is able to compensate for the predominately inductive power factor of typical residential and building loads (e.g., appliances, etc.), because of its leading current draw. As a consequence the circuit can utilize at least part of the inductive current load that would otherwise be reflected back to the source or wasted.

### FIELD

The present innovation relates generally to an electrical power supply system, devices employing the system, and methods associated with the system. Specifically, the present innovation relates to techniques for reducing power output without decreasing power use by employing a capacitive ballast to power one or more loads from an AC source.

### BACKGROUND

FIG. 1 illustrates an example power transmission system 100. The transmission system 100 includes a power plant 102 that supplies power to a plurality of locations, such as a residence 104, via a series of transmission lines 106. The locations will often contain one or more appliances that draw current from the power provided as required. For example, the residence 104 may contain one or more appliances 108, such as a television set 108A, a coffee maker 108b, a stove 108c, and so forth. Each of the appliances 108 will draw current from the power provided via the transmission line 106 when necessary, such as when the appliances 108 are turned on or powering a display.

Due to the predominately inductive nature of many appliances 108, the current drawn by the appliances 108 typically lags behind the voltage provided by the power plant 102. This current lag results in a low power factor for the transmission system 100. For instance, if the current lags far enough behind the voltage provided, then the there is effectively no power drawn, which results in a zero (0) power factor. Whereas optimal power consumption would result in a power factor of one (1).

When the current drawn by the appliances 108 lags behind the voltage provided, the appliances 108 end up drawing only a portion of the provided power, and reflecting most of the remaining power back to the power plant 102. This can create tremendous expense for the power plant 102, which in turn can be passed onto consumers in the form of higher prices and penalties. On average, a residence 108 only uses about half of the provided power (e.g., power factor of 0.5), and reflects the balance back to the power plant 102. Consequently, it would be desirable to have a technique for providing power to one or more loads via the power reflected from other devices (e.g., appliances 108) that could reduce the total power reflection of a location.

### SUMMARY

The following presents a simplified summary of one or more aspects in order to provide a basic understanding of such aspects. This summary is not an extensive overview of all contemplated aspects, and is intended to neither identify key or critical elements of all aspects nor delineate the scope of any or all aspects. Its sole purpose is to present some concepts of one or more aspects in a simplified form as a prelude to the more detailed description that is presented later.

In accordance with one or more aspects and corresponding disclosure thereof, various aspects are described in connection with powering one or more loads from an AC source using a capacitive ballast. According to related aspects, a system for powering a set of loads from an alternating current source using a capacitive ballast is provided. The system includes a current limiting protection component that shields the set of loads against current from line transients, a reactive ballast that produces a leading current draw relative to the voltage from the alternating current source, and a transient protection component that suppresses line transients.

Another aspect relates to a circuit that includes a resistor that protects a set of light emitting diodes against current from line transients, a first capacitor that acts as a ballast and creates a leading current draw relative to the voltage from an alternating current source, and a second capacitor that protects the set of light emitting diodes by suppressing line transients.

Yet another aspect relates to a capacitive ballast circuit facilitating control of a set of light emitting diode. The capacitive ballast circuit includes a current limiting device that protects the set of light emitting diodes against current from line transients, wherein the current limiting device is at least one of a resistor, fuse, or fusible resistor, and a capacitive voltage divider that includes a first capacitor that operates as a ballast and creates a leading current draw relative to the voltage from an alternating current source, and a second capacitor that protects the set of light emitting diodes by suppressing line transients, wherein the voltage divider provides a voltage to the set of light emitting diodes that is a fraction of the voltage from the input alternating current source.

To the accomplishment of the foregoing and related ends, the one or more aspects comprise the features hereinafter fully described and particularly pointed out in the claims. The following description and the annexed drawings set forth in detail certain illustrative features of the one or more aspects. These features are indicative, however, of but a few of the various ways in which the principles of various aspects may be employed, and this description is intended to include all such aspects and their equivalents.

### BRIEF DESCRIPTION OF THE DRAWINGS

The above and other objects and advantages of the present innovation will be apparent upon consideration of the following detailed description, taken in conjunction with the accompanying drawings, in which like reference characters refer to like parts throughout, and in which:

FIG. 1 illustrates an example power transmission system;

FIG. 2 illustrates an example system for powering one or more loads from an alternating current source in accordance with an aspect of the subject innovation;

FIG. 3 illustrates an example system for powering one or more loads from an alternating current source in accordance with an aspect of the subject innovation; and

FIGS. 4-7 illustrate example circuits for powering one or more loads from an alternating current source in accordance with an aspect of the subject innovation.

### DETAILED DESCRIPTION

Various aspects are now described with reference to the drawings. In the following description, for purposes of explanation, numerous specific details are set forth in order to provide a thorough understanding of one or more aspects. It may be evident, however, that such aspect(s) may be practiced without these specific details.

Moreover, the term “or” is intended to mean an inclusive “or” rather than an exclusive “or.” That is, unless specified otherwise, or clear from the context, the phrase “X employs A or B” is intended to mean any of the natural inclusive permutations. That is, the phrase “X employs A or B” is satisfied by any of the following instances: X employs A; X employs B; or X employs both A and B. In addition, the articles “a” and “an” as used in this application and the appended claims should generally be construed to mean “one or more” unless specified otherwise or clear from the context to be directed to a singular form.

Various aspects or features will be presented in terms of systems that may include a number of devices, components, modules, and the like. It is to be understood and appreciated that the various systems may include additional devices, components, modules, etc. and/or may not include all of the devices, components, modules etc. discussed in connection with the figures. A combination of these approaches may also be used.

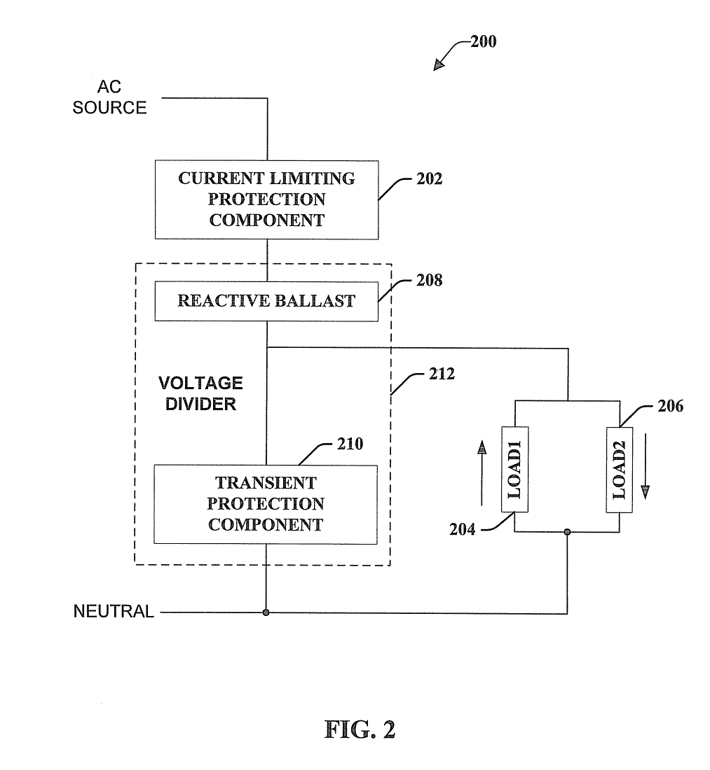

Turning now to FIG. 2, an example system for powering one or more loads from an AC source is shown in accordance with an aspect of the subject innovation. The system 200 includes a current limiting protection component 202 that defends a first load 204 and a second load 206 against potentially harmful power disruptions, such as current from line transients, etc. It is to be appreciated that current limiting protection component 202 can include a number of electrical components including but not limited to a resistor, a fuse, a fusible resistor, and so forth.

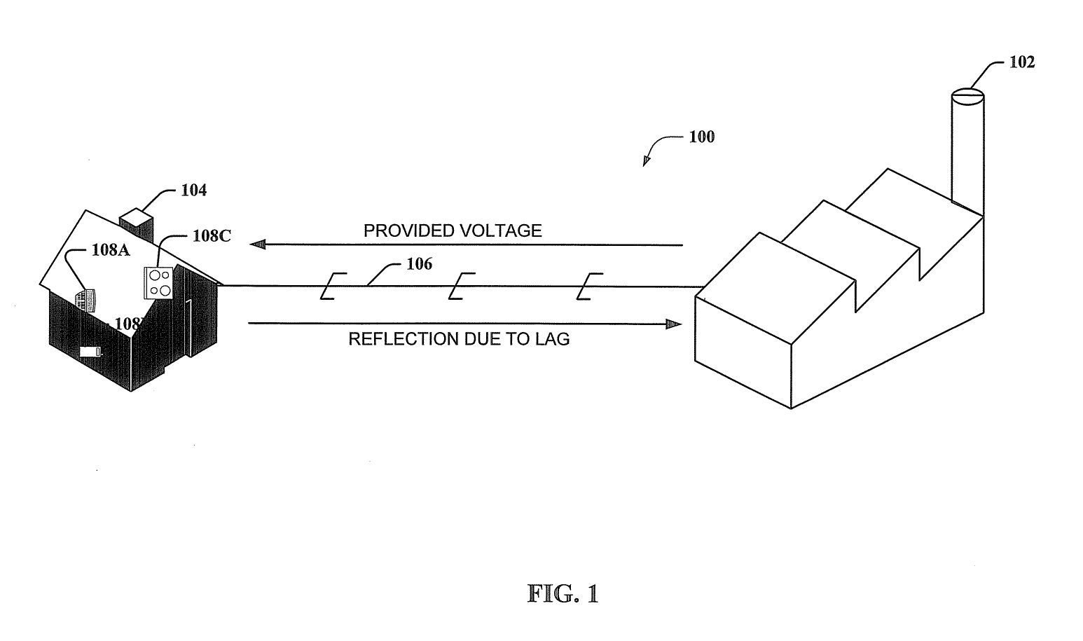

A reactive ballast 208 enables the system 200 to draw current from the AC source in a leading fashion. In other words, the current drawn by the system 200 will lead the voltage from the AC source. The leading draw of the system 200 can compensate for the predominately inductive power factor of typical appliances and building loads. In other words, the reflective current part of the inductive load current that would typically would be reflected back to the power plant can be exploited, harnessed, or otherwise utilized by the reactive ballast and used to power the loads 204 and 206. This can result in a reduction of total current drawn from a power transmission system for a location, such as the residence illustrated in FIG. 1.

A transient protection component 210 suppresses line transients or otherwise shields the loads 204 and 206 from voltage spikes. In addition, the reactive ballast 208 and transient protection component 210 can be arranged, placed, or otherwise implemented in a manner to form a voltage divider 212. The voltage divider 212 can produce an output voltage for the loads 204 and 206 that is a fraction of the input voltage supplied via the AC source. For example, the loads 204 and 206 can be light emitting diodes that require approximately two (2) volts each for operation, whereas the AC source can be a standard US electrical outlet that provides 120V. Consequently, it may be desirable to reduce or divide the voltage for correct operation of the loads 204 and 206. Additionally or alternatively, the voltage divider 212 can be implemented separately from the reactive ballast 208 and/or transient protection component 210.

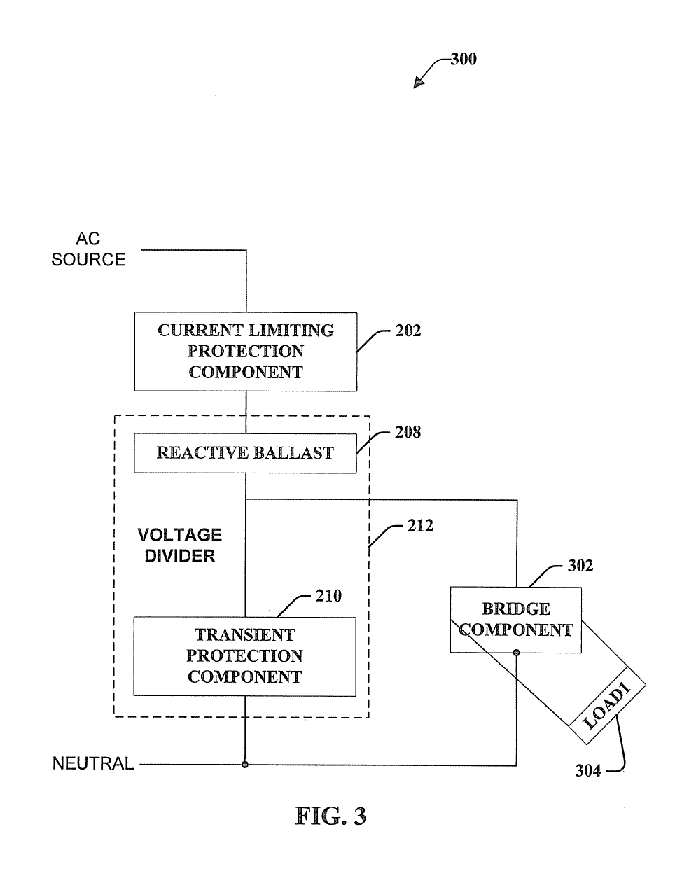

The loads 204 and 206 are illustrated as being connected in an inverse parallel arrangement to accommodate the alternating current (AC). Additionally or alternatively, as shown in FIG. 3, a bridge component 302 can be used to convert the supplied AC from the source into a direct current (DC) output. The bridge component 302 can include but is not limited to a bridge rectifier, diode bridge, and so forth. The DC output supplied from the bridge component 302 can be used to power one or more DC loads, such as a load 304. For example, the load 304 can be a standard LED requiring DC input for typical operation, and the bridge component 302 can be a diode bridge that converts the AC output of the voltage divider 212 to DC for use by the LED (e.g., load 304). It is to be appreciated that the foregoing represents but a few examples, and that many other exemplary embodiments are possible within the scope of the subject innovation.

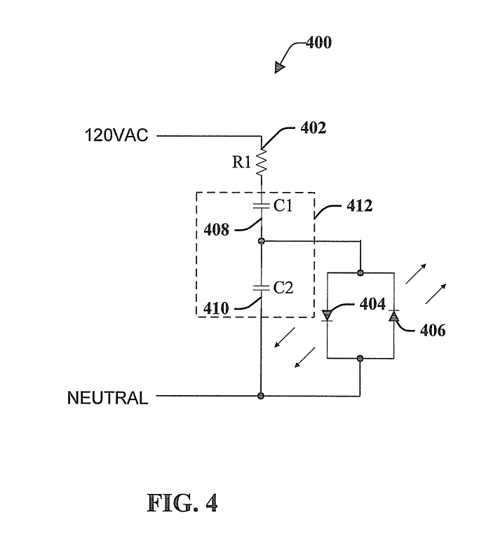

FIG. 4 illustrates an example circuit for powering one or more loads from an AC source using a capacitive ballast in accordance with an aspect of the subject innovation. The circuit 400 includes a resistor 402 that acts to protect a first load 404 and a second load 406 against potentially harmful power disruptions, such as current from line transients, and so forth by limiting the current in the system 400. The loads 404 and 406 are shown as light emitting diodes (LEDs). A first capacitor 408 operates as a reactive ballast or ballast capacitor. As discussed previously, the first capacitor 408 enables the current draw of the circuit 412 to lead the voltage from the AC source.

Due to the fact that the circuit 400 has a leading current draw, it is capable of compensating for the predominately inductive power factor of typical appliances and building loads. In other words, inductive loads, such as many household appliances, will reflect power back to a power plant, because the current of the inductive loads typically lags the voltage provided by the power plant. The circuit 400 can exploit, harness, or otherwise utilize the power that is typically reflected back to the power plant to power the diodes 404 and 406. The circuit 400 draws current from the voltage source (e.g., 120 VAC source); however, since the circuit 400 can utilize power that is typically reflected back to the power plant, it can essentially power the LEDs 404 and 406 using wasted energy (e.g., free energy). This can result in a reduction of total current drawn from a power transmission system for a location, such as the residence 104 illustrated in FIG. 1.

A second capacitor 410 suppresses line transients or otherwise shields the LEDs 404 and 406 from voltage spikes. In addition, the first capacitor 408 and second capacitor 410 are implemented to form a capacitive voltage divider 412. The voltage divider 412 produces a drive voltage for the LEDs 404 and 406 that is a fraction of the input voltage supplied, in accordance with the following equation:

$${V}_{out} = {V}_{in} * \frac{{C}_{1}}{C 1 + {C}_{2}}$$

wherein Vₒᵤₜ is the drive voltage provided to the LEDs 404 and 406, Vᵢₙ is the input or source voltage (e.g., 120 VAC), C1 is the capacitance value of the first capacitor 408, and C2 is the capacitance value of the second capacitor 410.

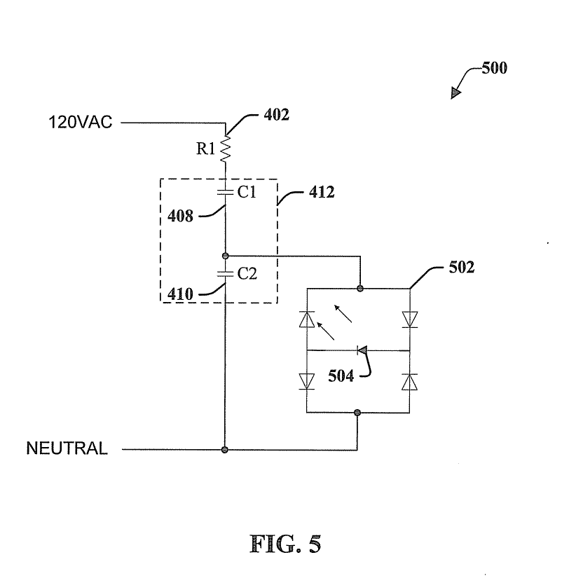

As discussed supra, the LEDs 404 and 406 are illustrated as being connected in inverse parallel to accommodate the alternating current (AC). Additionally or alternatively, as shown in FIG. 5, a diode bridge 502 can be used to convert the supplied AC from the source into a direct current (DC) output. The DC output supplied from the diode bridge 502 can be used to power one or more DC loads, such as a LED 504.

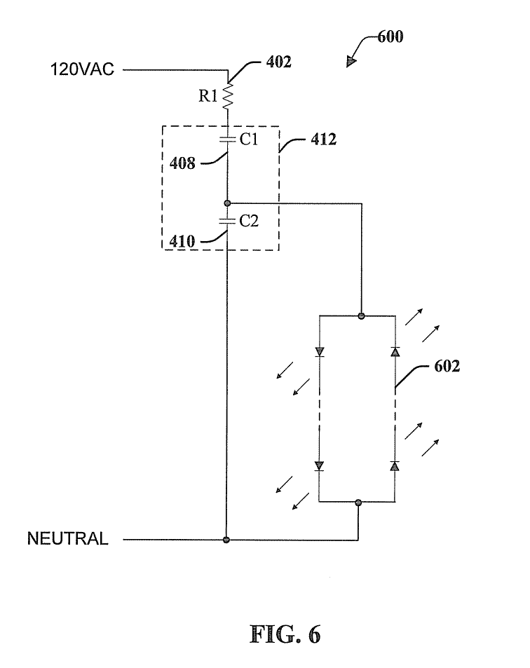

Turning now to FIG. 6, an example circuit for powering a plurality of loads from an AC source using a capacitive ballast is shown in accordance with an aspect of the subject innovation. In FIG. 4, the circuit 400 is illustrated as having two LEDs connected to the circuit 400 in inverse parallel. Additionally or alternatively, a plurality of LEDs 602 can be connected in a pair of series strings and each string can be connected in inverse parallel. This arrangement enables a greater number of LEDs 602 to be connected to the circuit 600, which can result in a more luminous LED display while still providing the benefit of a leading current draw capable of compensating for the predominately inductive power factor of typical appliances and building loads.

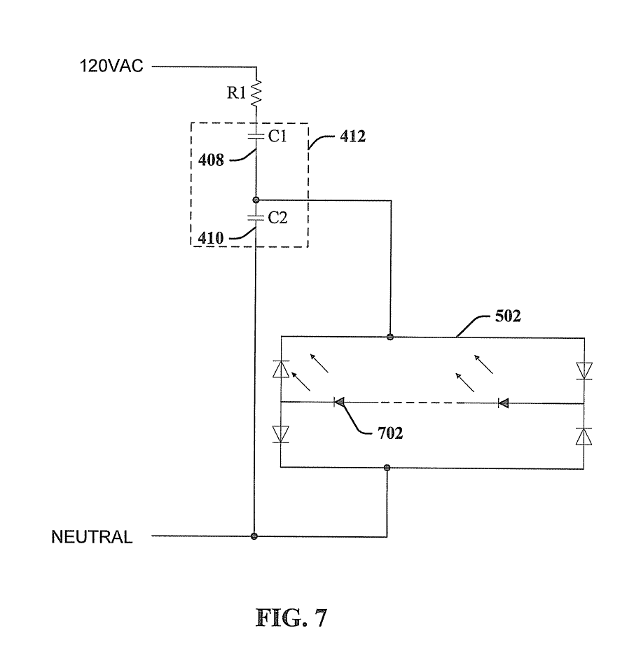

Furthermore, as shown in FIG. 7, the diode bridge 502 can be used to convert the supplied AC into a direct current (DC) output. The DC output from the diode bridge 502 can be used to power a plurality of LEDs 702 connected in series across the diode bridge 502. As discussed above, a plurality of LEDs 702 can generate a LED display with greater luminosity that compensates for the predominately inductive power factor of typical appliances and building loads.

As used herein, the term “relative to” means that a value A established relative to a value B signifies that A is a function of the value B. The functional relationship between A and B can be established mathematically or by reference to a theoretical or empirical relationship. As used herein, coupled means directly or indirectly connected in series by wires, traces or other connecting elements. Coupled elements may receive signals from each other.

The various illustrative logics, logical blocks, modules, and circuits described in connection with the embodiments disclosed herein may be implemented or performed with a general purpose processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general-purpose processor may be a microprocessor, but, in the alternative, the processor may be any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration. Additionally, at least one processor may comprise one or more modules operable to perform one or more of the acts, steps and/or actions described above.

While the foregoing disclosure discusses illustrative aspects and/or embodiments, it should be noted that various changes and modifications could be made herein without departing from the scope of the described aspects and/or embodiments as defined by the appended claims. Furthermore, although elements of the described aspects and/or embodiments may be described or claimed in the singular, the plural is contemplated unless limitation to the singular is explicitly stated. Additionally, all or a portion of any aspect and/or embodiment may be utilized with all or a portion of any other aspect and/or embodiment, unless stated otherwise.

What is claimed is:

1. A system for powering a set of loads from an alternating current source using a capacitive ballast, comprising:
a current limiting protection component that shields the set of loads against current from line transients;
a reactive ballast that produces a leading current draw relative to the voltage from the alternating current source; and
a transient protection component that suppresses line transients.

2. The system of claim 1, further comprising a voltage divider that provides a voltage to the set of loads that is a fraction of the voltage input from the alternating current source.

3. The system of claim 2, further comprising the voltage divider including the reactive ballast and transient protection component.

4. The system of claim 1, further comprising the set of loads being connected in inverse parallel to accommodate the alternating current.

5. The system of claim 1, further comprising the set of loads being connected in at least two sets of series strings, wherein the strings are connected in inverse parallel.

6. The system of claim 1, further comprising a bridge component that converts the alternating current to direct current.

7. The system of claim 6, further comprising the set of loads being connected to the bridge component in series.

8. The system of claim 6, wherein the bridge component is a diode bridge.

9. The system of claim 6, wherein the set of loads includes at least one light emitting diode.

10. The system of claim 1, wherein at least one of the current limiting protection component or the reactive ballast includes a capacitor.

11. The system of claim 1, wherein the current limiting protection component is at least one of a resistor, fuse, or fusible resistor.

12. A circuit, comprising:
a resistor that protects a set of light emitting diodes against current from line transients;
a first capacitor that acts as a ballast and creates a leading current draw relative to the voltage from an alternating current source; and
a second capacitor that protects the set of light emitting diodes by suppressing line transients.

13. The circuit of claim 12, further comprising a capacitive voltage divider that includes the first capacitor and second capacitor, and provides a voltage to the set of light emitting diodes that is a fraction of the voltage from the alternating current source.

14. The circuit of claim 13, further comprising a set of series wired strings including the light emitting diodes, wherein the set of series wired strings are connected to the capacitive voltage divider in series relative to each other.

15. The circuit of claim 13, further comprising a diode bridge that is connected to the voltage divider and converts the alternating current into a direct current output.

16. The circuit of claim 15, wherein the set light emitting diodes are connected to the direct current output of the diode bridge in series.

17. A capacitive ballast circuit facilitating control of a set of light emitting diodes, comprising:
a current limiting device that protects the set of light emitting diodes against current from line transients, wherein the current limiting device is at least one of a resistor, fuse, or fusible resistor; and
a capacitive voltage divider that includes a first capacitor that operates as a ballast and creates a leading current draw relative to the voltage from an alternating current source, and a second capacitor that protects the set of light emitting diodes by suppressing line transients, wherein the voltage divider provides a voltage to the set of light emitting diodes that is a fraction of the voltage from the alternating current source.

18. The capacitive ballast circuit of claim 17, further comprising at least two sets of series wired sets of light emitting diodes, wherein the sets of series wired sets of light emitting diodes are connected to each other in series and powered via the voltage divider.

19. The capacitive ballast circuit of claim 17, further comprising a diode bridge that is connected to the voltage divider and converts the alternating current into a direct current output, wherein the set of light emitting diodes are connected to the direct current output of the diode bridge in series.
